(19) United States
(12) Patent Application Publication
(10) Pub. No.: US 2025/0150934 A1
(43) Pub. Date: May 8, 2025

(54) RESOURCE MANAGEMENT FOR RELAY OPERATION

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US); Elliot Jen, Taipei City (TW)

(21) Appl. No.: 18/927,791

(22) Filed: Oct. 25, 2024

Related U.S. Application Data
(60) Provisional application No. 63/547,050, filed on Nov. 2, 2023.
(60) Provisional application No. 63/547,055, filed on Nov. 2, 2023.
(60) Provisional application No. 63/605,162, filed on Dec. 1, 2023.

(51) Int. Cl. H04W 40/22; H04W 88/10

(52) U.S. Cl. CPC H04W 40/22; H04W 88/10

(57) ABSTRACT

An access point (AP) station in a wireless network, the AP comprising: a communication interface to communicate with one or more relay stations (STAs); and a processor coupled to the communication interface, the processor configured to: establish a logical AP multi-link device (MLD) comprising the AP and the one or more relay STAs, wherein the logical AP MLD comprises an upper medium access control (UMAC) layer in the AP and a lower MAC (LMAC) layer in the one or more relay STAs; wherein an UMAC operation is performed at the AP and a LMAC operation is performed at the one or more relay STAs.

### CROSS-REFERENCE TO RELATED APPLICATION(S)

This application claims the benefit of priority from U.S. Provisional Application No. 63/547,050, entitled “RESOURCE SHARING FOR RELAY OPERATION IN NEXT GENERATION WI-FI NETWORKS” filed Nov. 2, 2023, U.S. Provisional Application No. 63/547,055, entitled “TRAFFIC STATISTIC EXCHANGE FOR RELAY OPERATION IN NEXT GENERATION WI-FI NETWORKS” filed Nov. 2, 2023, and U.S. Provisional Application No. 63/605,162, entitled “ARCHITECTURE AND SETUP FOR RELAY OPERATION IN NEXT GENERATION WLANS” filed Dec. 1, 2023, all of which are incorporated herein by reference in their entireties.

### TECHNICAL FIELD

This disclosure relates generally to a wireless communication system, and more particularly to, for example, but not limited to, resource management for relay operations.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides an access point (AP) station in a wireless network, the AP comprising: a communication interface to communicate with one or more relay stations (STAs) and a processor coupled to the communication interface. The processor is configured to establish a logical AP multi-link device (MLD) comprising the AP and the one or more relay STAs, wherein the logical AP MLD comprises an upper medium access control (UMAC) layer in the AP and a lower MAC (LMAC) layer in the one or more relay STAs, wherein an UMAC operation is performed at the AP and a LMAC operation is performed at the one or more relay STAs.

In some embodiments, an advertising function is provided by a UMAC layer of a relay STA and a traffic handling function is provided by the UMAC layer of the AP.

In some embodiments, the one or more relay STAs include a plurality of LMACs that are part of different MLDs and are controlled by the UMAC layer of the AP for relay operation.

In some embodiments, the processor is further configured to receive a message from the one or more relay STAs that includes information about a configuration of the one or more relay STAs.

In some embodiments, the message includes information about capabilities of the one or more relay STAs.

In some embodiments, the processor is further configured to transmit an advertisement message that includes information on the one or more relay STAs.

One aspect of the present disclosure provides a relay station (STA) station in a wireless network, the relay STA comprising: a communication interface to communicate with an access point (AP); and a processor coupled to the communication interface. The processor is configured to establish a logical AP multi-link device (MLD) comprising the AP and the relay STA, wherein the logical AP MLD comprises an upper medium access control (UMAC) layer in the AP and a lower MAC (LMAC) layer in the one or more relay STAs; wherein an UMAC operation is performed at the AP and a LMAC operation is performed at the relay STA.

In some embodiments, an advertising function is provided by a UMAC layer of the relay STA and a traffic handling function is provided by the UMAC layer of the AP.

In some embodiments, the relay STA further comprises a plurality of LMACs that are part of different MLDs and are controlled by the UMAC layer of the AP for relay operation.

In some embodiments, the processor is further configured to transmit a message to the AP that includes information about a configuration of the relay STA.

In some embodiments, the message includes information about capabilities of the relay STA.

In some embodiments, the processor is further configured to transmit an advertisement message that includes information on the relay STA.

In some embodiments, the relay STA further comprises one or more physical layers (PHYs), wherein the one or more PHYs are configured to communicate with one or more STAs and the one or more PHYs are configured to communicate with the AP.

In some embodiments, the relay STA transmits and receives traffic using a first PHY in the one or more PHYs.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates multi-link discovery and setup in accordance with an embodiment.

FIG. 5 illustrates an example smart home environment with one or more relays communicating with smart devices.

FIG. 6 illustrates a trigger frame in accordance with an embodiment.

FIG. 7 illustrates a modified HE variant user info field format in a multi-user (MU) request-to-send (RTS) triggered transmission opportunity sharing (TXS) Trigger frame in accordance with an embodiment.

FIG. 8 illustrates a modified EHT variant user info field format in the MU-RTS TXS Trigger frame in accordance with an embodiment.

FIG. 9 illustrates an example operation in accordance with an embodiment.

FIG. 10 illustrates an example operation of an AP sharing a portion of a transmission opportunity (TXOP) in accordance with an embodiment.

FIG. 11A illustrates an MU-RTS TXS frame in accordance with an embodiment.

FIG. 11B illustrates an EHT variant Common Info field of the trigger frame in accordance with an embodiment.

FIG. 12 illustrates a trigger dependent user info field format in accordance with an embodiment.

FIG. 13 illustrates a relay architecture with a split of operational stack in accordance with an embodiment.

FIG. 14 illustrates a relay architecture with UMAC on the STA in accordance with an embodiment.

FIG. 15 illustrates a flow chart of an example process by an AP of obtaining traffic statistics in accordance with an embodiment.

FIG. 16 illustrates a flow chart of an example process by a relay device of obtaining traffic statistics in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

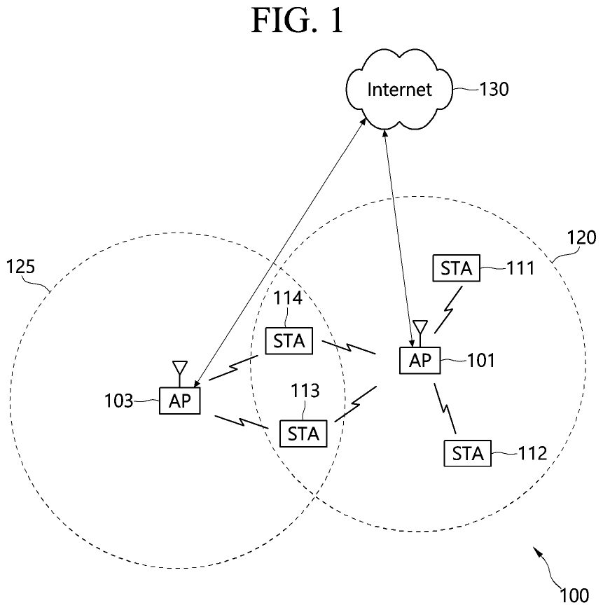

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

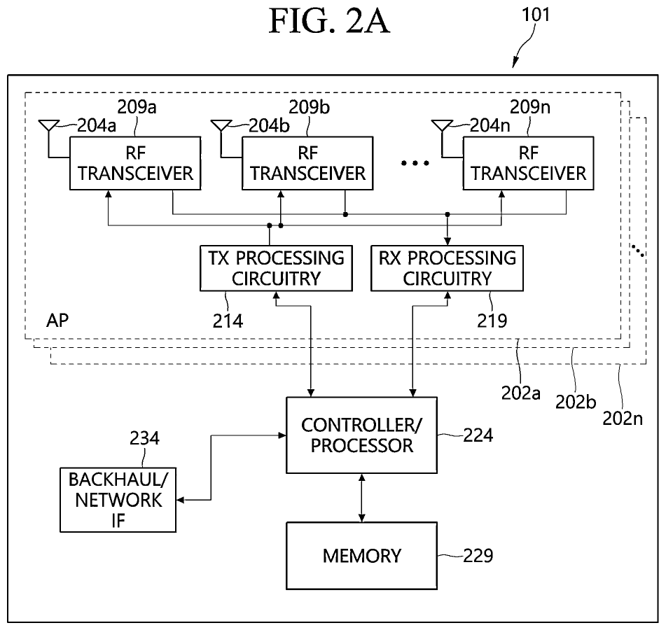

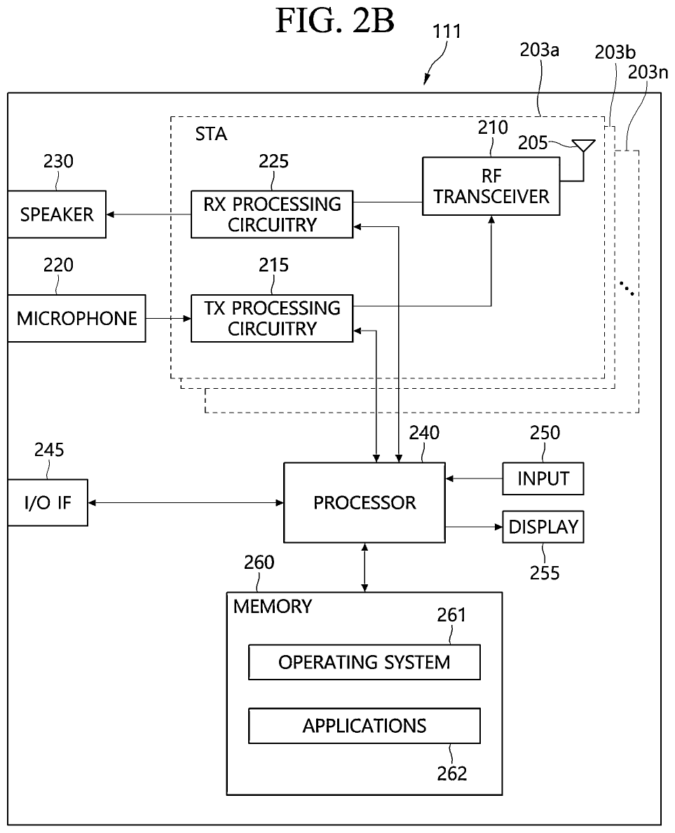

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

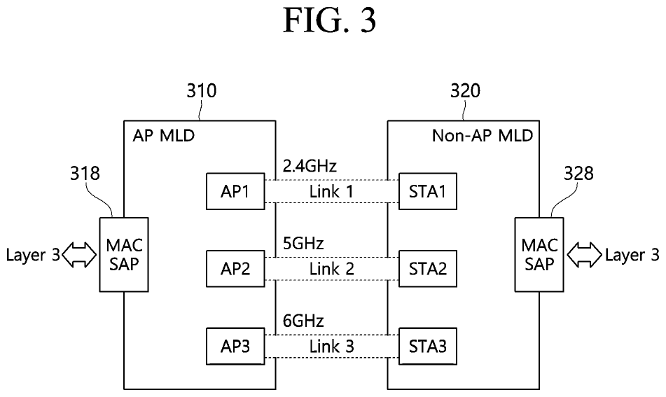

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D4.1, “Wireless LAN Medium Access Control (MAC) and Physical Layer (PHY) Specifications.”

Multi-link operation may allow the discovery and setup of multiple links between an AP MLD and a non-AP MLD, where the discovery or the setup can take place over a single link.

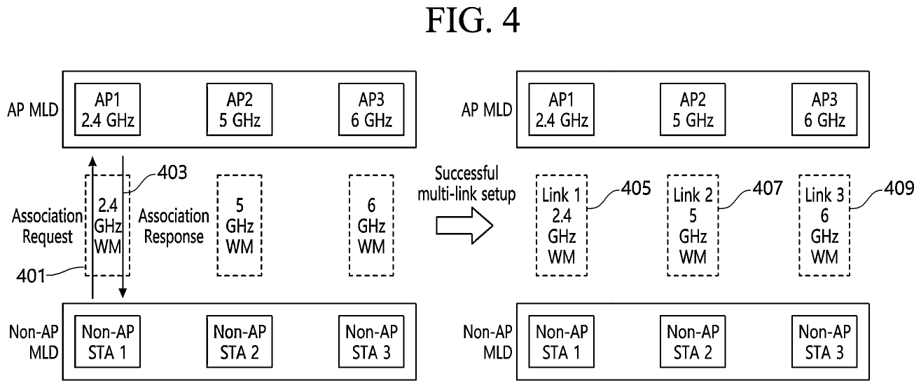

FIG. 4 illustrates multi-link discovery and setup in accordance with an embodiment. In particular, FIG. 4 illustrates an AP MLD communicating with a non-AP MLD. As illustrated, AP MLD is associated with AP1, AP2 and AP3, and non-AP MLD is associated with non-AP STA1, non-AP STA 2, and non-AP STA3. The non-AP MLD transmits an association request frame 401 to AP MLD. AP MLD then transmits an association response frame 403 to non-AP MLD. In FIG. 4, the association request frame 401 and the association response frame takes place over the 2.4 GHz link between the an AP MLD and a non-AP MLD, where the setup is for establishing three links between the AP MLD and the non-AP MLD: one link on the 2.4 GHz band, a second link on the 5 GHz band, and a third link on the 6 GHz band. After the successful setup, the three links, including link 1 at 2.5 GHz 405, link 2 at 5 GHz 407, and link 3 at 6 GHz 409, are established between the AP MLD and the non-AP MLD.

Embodiments in accordance with this disclosure may help increase the range of wireless connectivity of an access point so that users can get connectivity in areas where the access point signal is weak/not available. In some embodiments, a relay can be used for supporting this functionality. A relay can act as an intermediate node that can forward packets received from the AP to the non-AP. An example scenario for use of relay can be that of a smart home where there can be a number of devices such as TV, tablets, among other devices that have Wi-Fi support. These devices can act as relays to enhance the range of the access point.

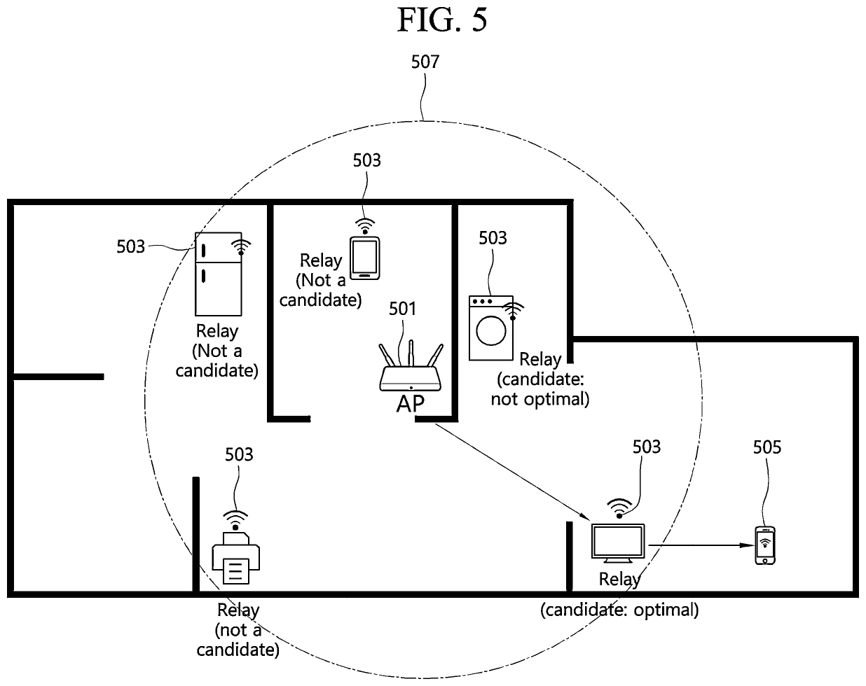

FIG. 5 illustrates an example smart home environment with one or more relays communicating with smart devices. In particular, FIG. 5 illustrates an AP 501 and several relay devices 503 and a STA 505. As illustrated, the AP's 501 range is shown by the dotted circle 507. When a user steps outside this circle 507, the user's device 505 may experience a poor connection and/or a connection may become unavailable. A relay, such as relays 503, can act as an intermediate node and forward the user's traffic so that even when the user is in weak connection areas, it can continue to receive Wi-Fi connectivity. In another scenario, the user can be inside the AP's range 507 but there can be a transmit power asymmetry. For instance, due to power constraints, the user's device 505 can be transmitting at lower power compared to the AP 501 (which can be wall powered and hence can transmit at higher power). Accordingly, the user STA 505 can be able to hear the AP's 501 transmission. However, on the uplink, the AP 501 may not be able to hear the user STA's 505 transmission. A relay can be useful in such scenarios as well.

During relay operation, it is possible that a relay can also have traffic besides the relayed traffic. For instance, if the relay is a mobile AP, the relay can have traffic from its own basic service set (BSS). If the relay is a STA associated with the AP, the relay can have its own traffic. These non-relayed traffic streams can generate frames that belong to the same TID(s)/AC(s) as the frames from the relayed traffic streams. When the AP shares time and/or frequency resources with a relay, it may be important to make an indication of which traffic the resources can be utilized for. For example, if the AP wants to share time and/or frequency resources with a relay to receive the traffic of an STA whose traffic the relay is relaying, the AP may need to be able to make such an indication to the relay. Otherwise, relay can send frames belonging to the same TID(s)/AC(s) which belong to the relay's own traffic streams or those of other STAs that are in the relay's BSS (e.g., if the relay is a Mobile AP). This behavior can result in the shared time and/or frequency resources to be utilized for a purpose other than the one that they are intended for. Embodiments in accordance with disclosure may provide techniques by which the AP can indicate to the relay the purpose for which the shared time and/or frequency resources can be utilized.

In some embodiments, when an AP requests traffic statistics from a relay, the AP may be able to request statistics of the STA whose traffic the relay is handling as well. Thus, the AP can get an idea of the STA's traffic that is backlogged at the relay and can be able to differentiate that from the relay's traffic statistics in the legacy report.

In some embodiments, when the root AP shares resources with the device that is acting as a relay for one or more of its STAs, the AP can make an indication of the purpose for which those resources are being shared with device. This can be done by transmission of a purpose indication message which can include at least one or more of the information items as indicated in Table 1.

TABLE 1

| Information | |
|---|---|
| items | Description |
| Purpose | An information item that can indicate the purpose of |
| indication | sharing the time and/or frequency resource. The AP |
| | can make a number of indications. For instance, the |
| | AP can share the resources and make an indication |
| | that the resources are being shared only for |
| | transmission of the STA's traffic. The AP can also |
| | share the resources for transmission of both the |
| | relay's traffic and the STA's traffic. The AP can |
| | share the resources that should be first used for |
| | transmission of STA's traffic and after STA's |
| | backlog is over the remaining can be used to |
| | transmit the relay's traffic. |
| STA | An information item that can indicate the STAs |
| indication | for whom the share time and/or frequency |
| | resource can be utilized by the relay. |

The above information items can be transmitted together or separately. They can be transmitted as a part of any existing frame/element/field/subfield in the standard or can be a part of newly defined ones.

In some embodiments, if the AP shares the time and/or frequency resources with multiple STA devices at the same time, the AP can make an indication to each STA device what is the purpose for which the time and/or frequency resources can be utilized. In some embodiments, if the AP performs a triggering operation using the basic trigger frame, it can indicate that the shared resources should be used for transmission of only the STA's traffic and not those of the relay's traffic.

In some embodiments, when transmitting a trigger frame, the purpose for which the resources are shared can be indicated in the trigger frame itself.

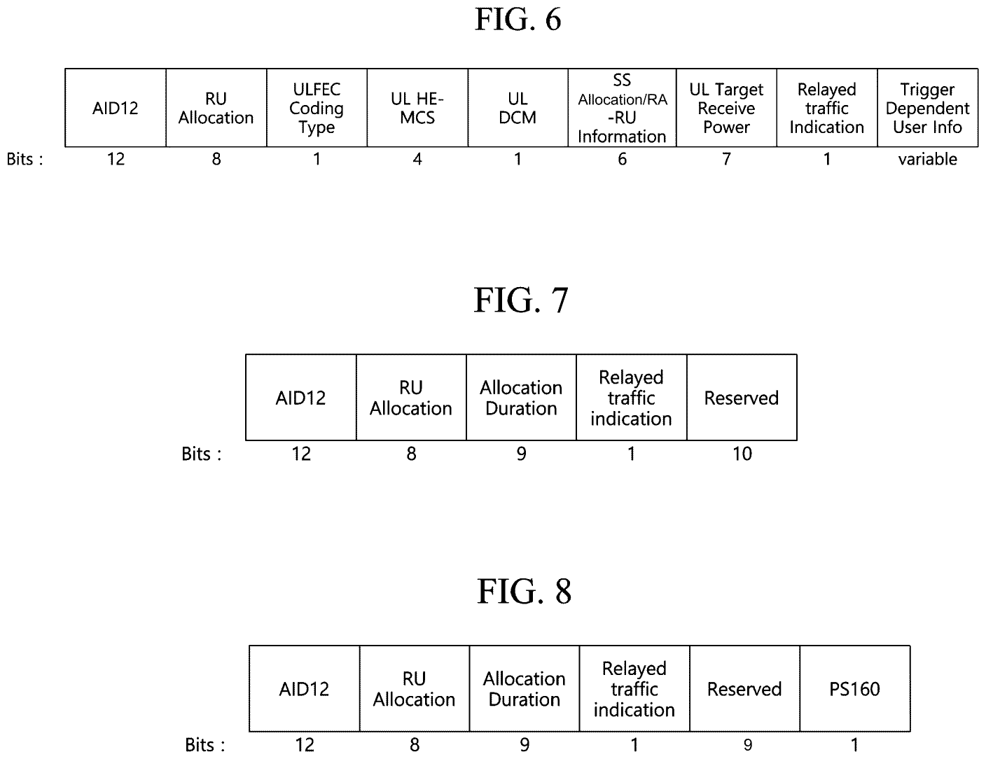

FIG. 6 illustrates a trigger frame in accordance with an embodiment. In particular, the trigger frame may include a modified user info field format in accordance with an embodiment. The trigger frame may include an AID12 field, a RU allocation field, a ULFEC coding type field, a UL HEMCS field, a UL DCM field, a SS allocation/RA-RU information field, a UL target receive power field, a relayed traffic indication field, and a trigger dependent user info field.

The AID12 field may determine which AID the RUs are allocated for.

The RU allocation field may communicate information about the allocation of resource units, including how a channel is divided into RUs, and how many users are assigned to each RU.

The ULFEC coding type field may specify the type of forward error correction (FEC) coding to use.

The UL HE MCS field may indicate the HE-MCS of a solicited HE TB PPDU.

The UL DCM field may indicate the DECM of a solicited HE TB PPDU.

The SS allocation field may indicate the spatial streams of a solicited HE TB PPDU and the format.

The UL target receive power field may indicate the expected receive signal power, measured at the AP's antenna connector and averaged over the antennas, for the HE portion of the HE TB PPDU transmitted on the assigned RU.

The relayed traffic indication bit field can be set to 1 to indicate that the shared resources can be utilized for transmission of the STA's traffic and not that of the relay's traffic. In some embodiments, if the bit is set to 0, then the shared resource can be utilized for transmission of the relay's traffic. In some embodiments, when the bit is set to 0, then the shared resource can be utilized for transmission of both relay's traffic and the STA's traffic.

In some embodiments, the AID12 subfield can be set to a value equal to the AID value of an STA whose traffic is being relayed by the relay to the AP to indicate to the relay that the assigned time and/or frequency resource has to be used/prioritized for the STA's traffic. If a relay receives a trigger frame with a user info field whose AID 12 subfield has a value equal to the AID value of an STA whose traffic it is relaying, then the relay can utilize that time and/frequency resource for the STA whose AID value matches the value in the AID12 subfield.

In some embodiments, when the AID12 subfield is set to a value equal to the AID value of a STA that the relay is serving and if the relayed traffic indication is set to 1, then it can indicate that the shared time and/or frequency resource can be utilized for the relayed traffic. In some embodiments, when the AID12 subfield is set to a value equal to the AID value of a STA that the relay is serving and if the relayed traffic indication is set to 0, then it can indicate that the time and/or frequency resource can be utilized for both relayed traffic and the relay's own traffic.

The trigger dependent user info field can be present to indicate that the STAs for whom the relay can use the shared time and/or frequency resource.

In some embodiments, if the trigger frame is a multi-user (MU) request to send (RTS) triggered TXOP sharing (TXS) Trigger frame, then the modified HE variant user info field can have a format as shown in FIG. 7 in accordance with an embodiment.

FIG. 7 illustrates a modified HE variant user info field format in the MU-RTS TXS Trigger frame in accordance with an embodiment. The frame may include an AID12 field, a RU allocation field, an allocation duration field, a relayed traffic indication field, and a reserved field.

The AID12 field may determine which AID the RUs are allocated for.

The RU allocation field may communicate information about the allocation of resource units, including how a channel is divided into RUs, and how many users are assigned to each RU.

The allocation duration field may provide duration information regarding an allocation.

The relayed traffic indication bit field can be set to 1 to indicate that the shared resources can be utilized for transmission of the STA's traffic and not that of the relay's traffic. In some embodiments, if the bit is set to 0, then the shared resource can be utilized for transmission of the relay's traffic. In some embodiments, when the bit is set to 0, then the shared resource can be utilized for transmission of both the relay's traffic and the STA's traffic.

The reserved field may be reserved.

In some embodiments, if the trigger frame is a MU-RTS TXS Trigger frame, then the modified extremely high throughput (EHT) variant user info field format can be as shown in FIG. 8 in accordance with an embodiment.

FIG. 8 illustrates a modified EHT variant user info field format in the MU-RTS TXS Trigger frame in accordance with an embodiment. The frame may include an AID12 field, a RU allocation field, an allocation duration field, a relayed traffic indication field, a reserved field and a PS160 field.

The AID12 field may determine which AID the RUs are allocated for.

The RU allocation field may communicate information about the allocation of resource units, including how a channel is divided into RUs, and how many users are assigned to each RU.

The allocation duration field may provide duration information regarding an allocation.

The relayed traffic indication bit field can be set to 1 to indicate that the shared resources can be utilized for transmission of the STA's traffic and not that of the relay's traffic. In some embodiments, if the bit is set to 0, then the shared resource can be utilized for transmission of the relay's traffic. In some embodiments, when the bit is set to 0, then the shared resource can be utilized for transmission of both the relay's traffic and the STA's traffic.

The reserved field may be reserved.

The PS160 field may indicate the RU allocation is in one or more primary or secondary channels.

In some embodiments, when the user info field indicates that the shared resource has to be used for the STA's traffic, the trigger dependent user info subfield parameters can be interpreted as those for the STA's traffic.

In some embodiments, there can be a trigger dependent user info field that can be present to indicate that the STAs for whom the relay can use the shared time and/or frequency resource. In some embodiments, the trigger dependent user info field can include the AIDs of the STAs for whom the relay can use the shared time and/or frequency resource.

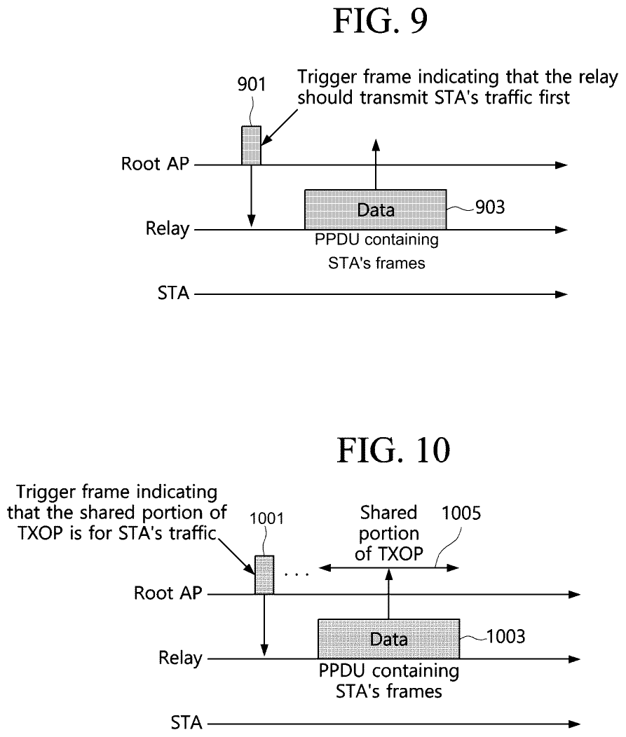

FIG. 9 illustrates an example operation in accordance with an embodiment. In particular, FIG. 9 illustrates communication among a root AP, a relay, and a STA. In some embodiments, when the AP triggers the relay for uplink transmission, the trigger frame can indicate that the relay can transmit the STA's frame first using the shared resource. As illustrated the AP transmits a trigger frame 901 to the relay, where the trigger frame 901 indicates that the relay should transmit the STA's traffic first. Accordingly, the relay transmits a physical layer protocol data unit (PPDU) 903 to the AP that includes the STA's frames.

In some embodiments, when the AP shares a portion of its transmission opportunity (TXOP) with the STA, the AP can indicate in the trigger frame (e.g., MU-RTS TXS trigger frame) that the portion of TXOP shared can be used for transmission of the STA's traffic.

FIG. 10 illustrates an example operation of an AP sharing a portion of a TXOP in accordance with an embodiment. In particular, FIG. 10 illustrates communication among a root AP, a relay, and a STA. The AP transmits a trigger frame 1001 to the relay, where the trigger frame 1001 indicates that the shared portion of a TXOP 1005 is for the STA's traffic. During the shared portion of the TXOP 1005, the relay transmits a PPDU 1003 to the AP that includes the STA's frames.

In some embodiments, an AP that is capable of sharing resources with an indication of the purpose for which those resources can be used can make an advertisement of its capability in one or more frames that it transmits. The frames may be any type of frames including management frame such as beacon frames, probe request/response frames, among other types of frames.

In some embodiments, a relay that is capable of processing and responding to such an indication from the AP can advertise its capabilities in one or more frames that it transmits. The frames may be any type of frames including management frame such as beacon frames, probe request/response frames, among other types of frames.

As described herein, a requesting entity may be an entity that is requesting for the traffic statistics (e.g., AP). A target entity may be an entity whose traffic statistics are being requested (e.g., STA). An intermediate entity may be an entity that buffers the traffic of target entity and may have traffic of its own as well (e.g., own BSS traffic as in the case of a Mobile AP or its own user's traffic as in the case of a non-AP).

In some embodiments, when the requesting entity (e.g., AP) makes a request for traffic statistics of a target entity(s) (e.g., STA) from the intermediate entity (e.g., relay), it can transmit a target entity statistics request message. The request message can include at least one or more of the information items as indicated in Table 2.

TABLE 2

| Information | |
|---|---|
| item | Description |
| Target | An information item that can indicate if the request is for |
| entity(s) | the target entity(s)'s traffic. Based on this indication, the |
| statistics | intermediate entity can understand that it can report the |
| request | target entity(s)'s traffic statistics to the requesting entity. |
| indicator | |
| Target | An information item that can indicate the target entity(s) |
| entity(s) | whose traffic statistics is being requested by the |
| identifier | requesting entity. |

The above information items can be transmitted together or separately. They can be transmitted as a part of any existing frame/element/field/subfield in the standard or can be a part of newly defined ones.

In some embodiments, when the requesting entity (e.g., AP) makes a request for the traffic statistics of the intermediate entity (e.g., relay) from the intermediate entity (e.g., relay), it can transmit an intermediate entity statistics request message. The request message can include at least one or more of the information items as indicated in Table 3.

TABLE 3

| Information | |
|---|---|
| item | Description |
| Intermediate | An information item that can indicate if the request is for |
| entity | the intermediate entity's traffic statistic. Based on this |
| statistics | indication, the intermediate entity can understand that |
| request | it can report the intermediate entity's traffic statistics |
| indicator | to the requesting entity. |

The above information items can be transmitted together or separately. They can be transmitted as a part of any existing frame/element/field/subfield in the standard or can be a part of newly defined ones.

In some embodiments, when the requesting entity (e.g., AP) makes a request for the cumulative traffic statistics of both the target entity(s) as well as the intermediate entity, it can transmit a cumulative traffic statistics request message. The request message can include at least one or more of the information items as indicated in Table 4.

TABLE 4

| Information | |
|---|---|
| item | Description |
| Cumulative | An information item that can indicate if the request is for |
| entity | the cumulative traffic statistic. Based on this indication, |
| statistics | the intermediate entity can understand that it can report |
| request | the cumulative traffic statistics to the requesting entity. |
| indicator | |

The above information items can be transmitted together or separately. They can be transmitted as a part of any existing frame/element/field/subfield in the standard or can be a part of newly defined ones.

In some embodiments, the trigger type subfield in the common info field in the trigger frame can be used to make an indication. The trigger type field can carry values such as those shown in Table 5 for making the indication.

TABLE 5

| Trigger | |
|---|---|
| Type | |
| subfield | |
| value | Trigger frame variant |
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NFRP) |
| 8 | Ranging |
| 9 | Relayed Node Buffer Status Report Poll (RNBSRP) |
| 10-15 | Reserved |

When an intermediate entity receives a trigger whose trigger type subfield in the common info field has a value equal to that of the trigger type subfield value of a RNBSRP trigger, then the intermediate entity can transmit traffic statistics of either the target entity or the intermediate entity.

In some embodiments, a reserved bit of the common info subfield can be set to 1 to indicate if the traffic statistics can be that of the intermediate entity and to 0 to indicate that it can be of the target entity. The values are example values and can be different as well.

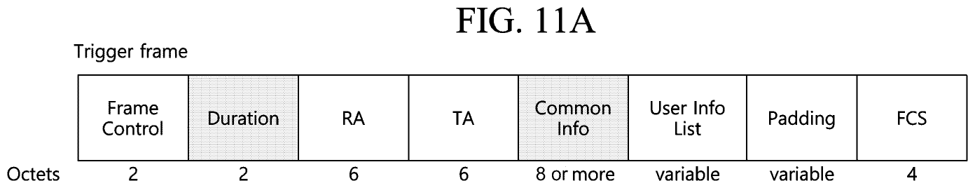

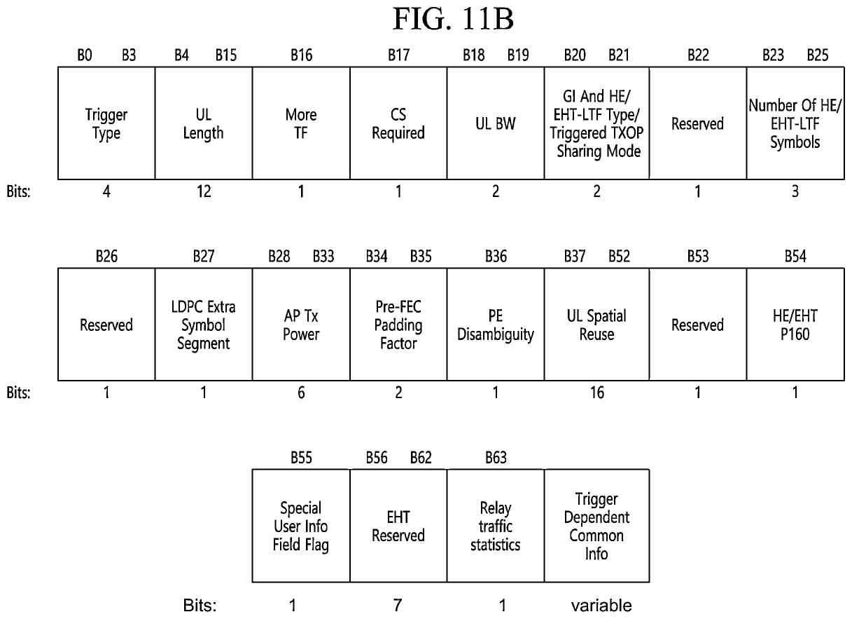

FIG. 11A illustrates an MU-RTS TXS frame in accordance with an embodiment. The MU-RTS TXS frame can include one or more fields, including, but not limited to, a frame control field, a duration field, a receiver address (RA) field, a transmitter address (TA) field, a Common Info field, a User Info List field, a Padding field, and a frame check sequence (FCS) field.

The Frame control field can include a value to indicate the type of frame. The Duration field may be set to the estimated time, in microseconds, required to transmit the pending frame(s). The Receiver Address (RA) field may include the address of the receiver of frame. The Transmitter Address (TA) field may include the address of the transmitter of the frame. The Common Info Field may indicate the MU-RTS TXS Mode and include one or more subfields, as described below. The User Info List may indicate a value of the bandwidth (BW) associated with the MU-RTS frame (and/or BW associated with the PPDU carrying the MU-RTS frame-for example, but not limited to, 320 MHz, 160+160 MHz, 240 MHz, 160+80 MHz). The Padding field may be used for additional padding to compensate for different lengths of different MU-RTS frames. The FCS field is a frame check sequence for error-detection.

FIG. 11B illustrates an EHT variant Common Info field of the trigger frame. In particular, the reserved bit that may be used may be called a relay traffic statistics field.

The EHT variant Common Info field of the trigger frame may include a Trigger Type field, a UL length field, a More Trigger Frame (TF) field, a Carrier Sense (CS) required field, an Up Link Bandwidth (UL BW) field, A DI and HE/E HT-LTF Type/Triggered TXOP Sharing Mode field, a Reserved Field, a Number of HE/EHT-LTF Symbols field, a Reserved field, a Low-Density Parity Check (LDPC) Extra Symbol Segment field, a AP transmitter (TX) power field, a Pre-FEC Padding Factor field, a PE Disambiguity field, a UL Spatial Resue field, a Reserved field, a HE/EHT P160 filed, a Special User Info Flag field, a EHT Reserved field, a Relay Traffic Statistics field, and a Trigger Dependent Common Info field.

The trigger type field may indicate a MU-RTS trigger frame. The UL Length field may signal a length of the expected response frame. The More TF field may indicate whether or not a subsequent trigger frame is scheduled for transmission. The CS Required field is set to 1 to indicate that the STAs identified in the User Info fields are required to use Energy Detect (ED) to sense the medium and to consider the medium state and the Network Allocation Vector (NAV) in determining whether or not to respond. The UL BW field (Up Link Bandwidth) indicates the bandwidth of the transmission. The GI and HE/EHT LTF Type/Triggered TXOP Sharing Mode field indicates the guard interval and long training field (GI and HE/EHT-LTF) type of the HE or EHT TB PPDU response, and the field may switch meaning between GI and HE/EHT-LTF type and triggered TXOP sharing mode fields based on the trigger type.

The Reserved field is reserved. The Number of HE/EHT LTF Symbols field indicates the number of HE-LTF symbols present in the HE TB PPDU or EHT-LTF symbols present in the EHT TB PPDU, respectively. The Reserved field is reserved. The LDPC Extra Symbol Segment field indicates the status of the LDPC extra symbol segment. The AP TX Power field provides the Tx Power used to transmit the frame. The Pre-FEC Padding Factor field indicates the pre-FEC padding factor. The PE Disambiguity field indicates the PE disambiguity. The UL Spatial Reuse field carries the values to be included in the Spatial Reuse fields in the HE-SIG-A field of the solicited HE TB PPDUs. The Reserved field is reserved. The HE/EHT P160 field may indicate whether the solicited TB PPDU in the primary 160 MHz is an EHT TB PPDU or an HE TB PPDU. The Special User Info Flag field may indicate that a Special User Info field is included in the Trigger frame that contains the EHT variant Common Info field. The EHT Reserved field is reserved.

The Relay Traffic Statistics field may be set to 1 to indicate if the traffic statistics can be that of the intermediate entity and to 0 to indicate that it can be of the target entity.

The Trigger Dependent Common Info field is optionally present based on the value of the Trigger Type field.

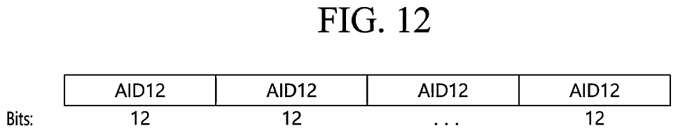

In some embodiments, when the relay traffic statistics field is set to a value to request the traffic statistics of the target node(s) and the trigger type subfield is set to the value of the trigger type subfield for RNBSRP, then the trigger can also include an indication of the target entity(s) whose traffic statistics are being requested. In some embodiments, if the target entity(s) indication is performed through the trigger dependent user info field, then an example format of the trigger dependent user info field that may be used is illustrated in FIG. 12 in accordance with an embodiment.

FIG. 12 illustrates a trigger dependent user info field format in accordance with an embodiment. The field may include one or more AID12 fields. In some embodiments, these AID12 values can be set to the AID value of the STA whose traffic statistics are being requested by the AP.

In some embodiments, when the intermediate entity receives a request from the requesting entity, it can generate a response that can include the relevant requested traffic statistics. The response message can include at least one or more of the information items as shown in Table 6.

TABLE 6

| Information | |
|---|---|
| item | Description |
| Target | An information item that can describe the target entity(s) |
| entity(s) | identifier. E.g., STA's MAC address, AID, etc. |
| identifier | |
| Target | An information item that can contain a description of the |
| entity(s) | traffic statistics of the target entity(s). E.g., ACI Bitmap, |
| traffic | delta TID, ACI High, Scaling factor, queue size high, |
| statistics | queue size all, etc. for the target node. These can be |
| | indicated in a cumulative manner or in an individual |
| | manner. |
| Timing | An information item that can describe the timing |
| information | information for the target node's traffic buffered |
| | at the intermediate node. E.g., enqueuer |
| | timestamp, expiration timestamp, etc. |
| Intermediate | An information item that can describe the intermediate |
| entity | entity identifier. E.g., relay's MAC address, AID, etc. |
| identifier | |
| Intermediate | An information item that can contain a description of |
| entity traffic | the traffic statistics of the intermediate entity. E.g., |
| statistic | ACI Bitmap, delta TID, ACI High, Scaling |
| | factor, queue size high, queue size all, etc. |
| | for the intermediate entity. |
| Cumulative | An information item that can contain the cumulative |
| traffic | traffic statistic of both the intermediate entity and |
| statistic | the target entity. |

The above information items can be transmitted together or separately. They can be transmitted as a part of any existing frame/element/field/subfield in the standard or can be a part of newly defined ones.

In some embodiments, if a requesting entity (e.g., an AP) can support such a traffic statistic report procedure, it can advertise the support in one or more frames that it transmits (e.g., management frames such as beacon frames, probe response frames, among others).

In some embodiments, if an intermediate entity (e.g., a relay) can support such a traffic statistic report procedure, it can advertise the support in one or more frames that it transmits. The frames may be management frames such as beacon frames, probe response frames among others if the relay is a AP/Mobile AP, or probe request frames, (re) association request frames, among others if the relay is a STA.

In some embodiments, a relay's operational stack can be split and part of it can operate on a different device.

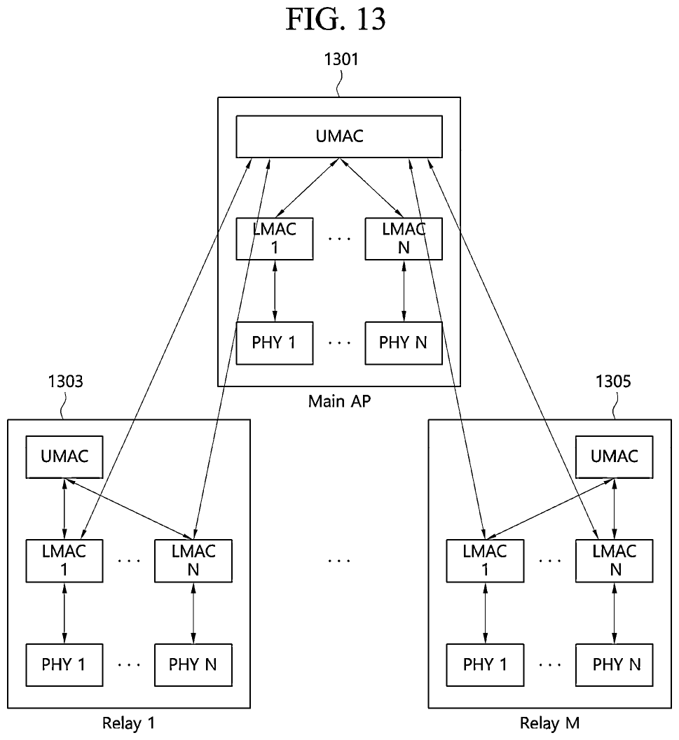

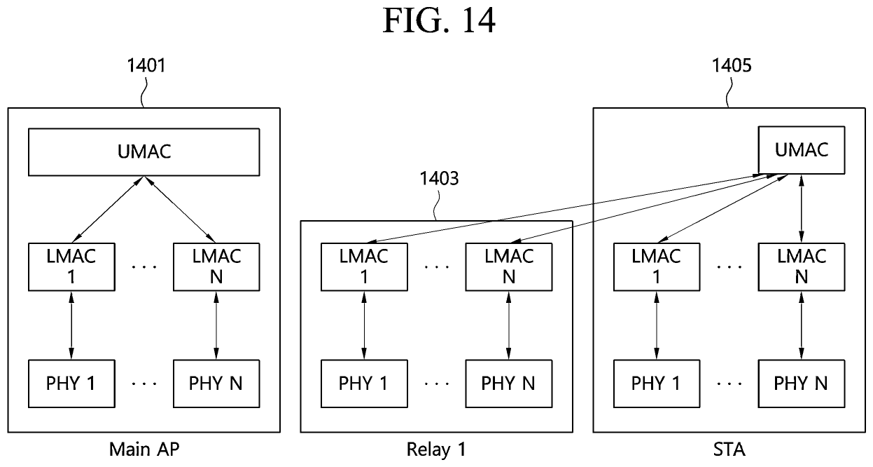

FIG. 13 illustrates a relay architecture with a split of operational stack in accordance with an embodiment. As illustrated, there is a main AP 1301 and there are supporting devices 1303 and 1305 which can act as a relay. These supporting devices 1303 and 1305 can act as relay and form a logical AP MLD/non-collocated AP MLD setup. The relays 1303 and 1305 can operate with only the lower MAC (LMAC) while the upper MAC (UMAC) functionalities of the relay can run on the main AP that the relay assists. Each of the AP 1301, and Relay 1 1303 to Relay M 1305 may have multiple PHY 1 to N (e.g., multiple radios). One use case for this architecture can be as follows. Suppose that a home network has one main AP and many low end devices that act as supporting APs that are installed in various rooms. Each of the low end supporting APs may host a LMAC only while depending on the main AP's UMAC. The low end supporting APs can act as relays for the main AP. In some embodiments, the relay's UMAC can operate on a STA as shown in FIG. 14 in accordance with an embodiment.

FIG. 14 illustrates a relay architecture with UMAC on the STA in accordance with an embodiment. As illustrated, the main AP 1401 may support UMAC and one to N LMACs, the relay 1403 may only support 1 to N LMACs, and the STA 1405 may support UMAC and 1 to N LMACs. Each of the AP 1401, and Relay 1 1303 and STA may have multiple PHY 1 to N (e.g., multiple radios). The relay's 1403 UMAC may operate on the STA 1405. The relay 1403 may be a low end relay may only host one to N LMACs. One possible use case of this architecture can be as follows. Suppose that a user purchases a low grade device to support the user's end devices. These low grade devices may not have the full functionality of a STA but can host a LMAC while depending on the user's end device's UMAC for its operation. These low end supporting STAs can act as relays.

In some embodiments, the relay can have a UMAC along with a LMAC on the same device along with a duplicate UMAC running on the main AP. The UMAC on the relay can provide basic UMAC functionalities (e.g., advertisement) and may not handle the traffic that the relay transmits/receives. The UMAC on the main AP can provide traffic handling functionalities.

In some embodiments, the relay can have the UMAC and the LMAC running on the same device. In some embodiments, the relay can have several LMAC(s) that can be part of different MLD(s) but can be controlled by a common UMAC for relay operation.

In some embodiments, the relay can have multiple PHY (e.g., multiple radios) on the same device. The relay can configure one or more of the radios as an AP and one or more of the radios can be configured as a non-AP. The radio configured as a non-AP can communicate with the main AP whereas the radio configured as the AP can communicate with the STA whose traffic the relay handles.

In some embodiments, there can be two (or more) MLDs one configured as a non-AP and the other as the AP. In certain embodiments, there can be a single MLD whose one or more STAs are configured as the non-AP and one or more are configured to operate as the AP.

In some embodiments, when the non-AP operating on the relay can transmit a message to the main AP to inform the main AP about the configuration. This message can include at least one or more of the information items as indicated in Table 7.

TABLE 7

| Information items | Description |
|---|---|
| Non-AP identifier | An information item that can describe the non-AP. |
| | E.g., the non-AP's MAC address. |
| AP identifier | An information item that can describe the AP of |
| | the relay. E.g., the AP's MAC address. |
| AP configuration | An information item that can describe the AP's |
| | configuration. E.g., the channel of operation, |
| | bandwidth, etc. |
| Non-AP | An information item that can describe the non-AP's |
| configuration | configuration. E.g., the channel of operation, |
| | bandwidth, etc. |
| AP capabilities | An information item that can describe the AP's |
| | capabilities. E.g., PHY capabilities such as |
| | supported rates, etc. |
| Non-AP | An information item that can describe the non-AP's |
| capabilities | capabilities. E.g., PHY capabilities such as |
| | supported rates, etc. |
| Relay feature | An information item that can indicate that the |
| indication | device can act as a relay. E.g., a bit that can |
| | take a predetermined value to make the |
| | indication. |

The above information items can be transmitted together or separately. They can be transmitted as a part of any existing frame/element/field/subfield in the standard or can be a part of newly defined ones.

In some embodiments, upon receiving the message, the main AP can be aware of the relay configuration and availability. The main AP can transmit a message to the relay to (re)configure the relay's non-AP and AP radios. The message can include at least one or more of the information items as indicated in Table 8.

TABLE 8

| Information | |
|---|---|
| items | Description |
| AP indicator | An information item that can describe the AP(s) that the |
| | main AP is referring to. E.g., the AP(s)'s identifier such |
| | as the MAC address. |
| AP | An information item that can describe the configuration |
| configuration | that the AP(s) referred to above can be configured to. |
| | E.g., the channel of operation, bandwidth, etc. |
| Non-AP | An information item that can describe the non-AP(s) |
| indicator | that the main AP is referring to. E.g., the non-AP(s)'s |
| | identifier such as the MAC address. |
| Non-AP | An information item that can describe the configurationt |
| configuration | hat the non-AP(s) referred to above can be configured |
| | to. E.g., the channel of operation, bandwidth, etc. |

The above information items can be transmitted together or separately. They can be transmitted as a part of any existing frame/element/field/subfield in the standard or can be a part of newly defined ones.

In some embodiments, the above message can be transmitted by the AP to the relay device in an unsolicited manner or upon request from the relay.

In some embodiments, the relay's radio(s) can be configured as a non-AP. The relay can receive and transmit using the same radio. The transmission can occur on the same link on which the packet is received from the AP or on a different link. In some embodiments, the relay and the STA can operate as peers (e.g., P2P operation).

In some embodiments, the relay setup can be discovered by other STAs based on advertisement by the device that hosts the relay's UMAC. The setup can be advertised by transmission of an advertisement message that can include at least one or more of the information items as indicated in Table 9.

TABLE 9

| Information | |
|---|---|
| items | Description |
| Relay | An information item that can be used to describe the |
| identifier | relay. E.g., the MAC address of the relay's LMAC, |
| | the link ID, relay ID, etc. |
| Relay | An information item that can be used to describe the |
| availability | relay's availability. E.g., if the relay is in doze state |
| | then there can be a bit that can make this indication. |
| Relay setup | An information item that can describe the relay setup. |
| indication | E.g., an encoding that can describe how the relay's |
| | UMAC has been setup. This can enable the STA |
| | to identify if the relay can have an additional |
| | delay due to the communication between the |
| | LMAC and the UMAC. |
| Relay | An information item that can indicate if the device |
| indication | is a relay or not. E.g., a bit that can indicate that |
| | the identifier indicated above corresponds to a relay. |

The above information items can be transmitted together or separately. They can be transmitted as a part of any existing frame/element/field/subfield in the standard or can be a part of newly defined ones.

In some embodiments, when the main AP advertises the relay setup, the main AP can include the advertisement message in one or more frames that it transmits (e.g., beacon frames, probe response frames, (re) association response frames, among others). In some embodiments, the main AP can advertise the relay as one of the STAs affiliated with it. The main AP can differentiate the relay from the other STAs affiliated with it by including an information item that can make such an indication. For example, a bit that can be set to a predetermined value to indicate that the LMAC is a relay and not a collocated LMAC, a relay flag bit, among others.

In some embodiments, when the relay device advertises the relay setup, the relay device can include the advertisement message in one or more frames that it transmits (e.g., beacon frames if the relay has a AP radio, action frames, among others).

In some embodiments, the relay's own advertisement can help the STA to discover the relay. In certain embodiments, the STA may need to discover the relay with the best end to end performance with the main AP. To assist the STA, the AP can include a performance indicator metric in one or more of the messages that it transmits. This can be an information item that can indicate an estimate of the communication rate for the path between the relay and the AP (e.g., net rate, downlink rate, uplink rate, etc.). In some embodiments, this can be an estimate of the communication rate for AP to relay path that the STA can get if it communicates via the relay. The relay can take into account the actual communication rate and if it is currently using the link for other traffic (e.g., relay's own traffic, traffic of relay's BSS if relay is a Mobile AP/AP, traffic of other STAs which the relay is serving, etc.) it can estimate how much communication rate can be experienced by a new STA when it starts to communicate via the relay. The relay can update this rate each time an STA joins the relay. For MLO operation, this can be either a per link estimate and/or an aggregate estimate. This can help the STA to understand the relay whose link with the main AP has the highest performance metric. In some embodiments, the STA can perform some measurements to estimate the performance indicator metric's value for the available relays. The STA can perform these measurements by transmitting a measurement request message to the main AP or the relay. Upon receipt of the request message, the relay and the STA can perform the measurement to determine the performance metric value for the relay to the STA link.

In some embodiments, when the STA plans to switch to the relay, the STA can transmit a relay switch message to the main AP. The message can include at least one or more of the information items as indicated in Table 10.

TABLE 10

| Information | |
|---|---|
| items | Description |
| Relay | An information item that can indicate the relay to |
| indicator | which the STA wants to switch to. |
| STA indicator | In the case of MLO operation, the STA can be a |
| | MLD. This information item can indicate which |
| | of the STAs affiliated with the non-AP MLD |
| | want to transmit to the main AP using the relay. |
| Switch time | An information item that can indicate the time |
| | at which the switching can happen. E.g., the |
| | number of TBTTs from the current TBTT |
| | at which the switch can occur. |
| Reason code | An information item that can indicate ther |
| | eason for transmitting the above switch message. |

The above information items can be transmitted together or separately. They can be transmitted as a part of any existing frame/element/field/subfield in the standard or can be a part of newly defined ones.

In some embodiments, the STA can perform the AP to relay switch at association itself by including the relay switch message in one or more of the frames exchanged during association. In some embodiments, the frames may be any of a variety of frames including (re) association request frames among other types of frames.

In some embodiments, the main AP can perform the switch of an STA to the relay. For example, upon detection of poor signal strength, poor data rates, etc. The main AP can transmit a switch message in an unsolicited manner to the STA.

In some embodiments, when one or more of the STAs of a non-AP MLD switch from the main AP to the relay, the main AP's UMAC can start to forward the frames of those STAs to the corresponding relays. The main AP's UMAC can also start to receive the uplink traffic of the non-AP MLD via the relay.

In some embodiments, when one or more of the STAs of a non-AP MLD switch from the main AP to the relay, the relay can start to receive the uplink traffic of those STAs and forward the downlink traffic received from the AP to those STAs. When handling the traffic, in order to reduce the delay, the relay can also bypass the UMAC and handle the traffic within the LMAC itself. In some embodiments, if the relay has both the UMAC and the LMAC operating on it, the relay can transmit received fames from the non-AP LMAC to the AP LMAC without going through the UMAC. This can help to save any other delays from the protocol stack.

In some embodiments, when one or more of the STAs of a non-AP MLD switch from the main AP to the relay, those STAs of the non-AP MLD can start to receive downlink traffic from those relays and forward uplink traffic to those relays.

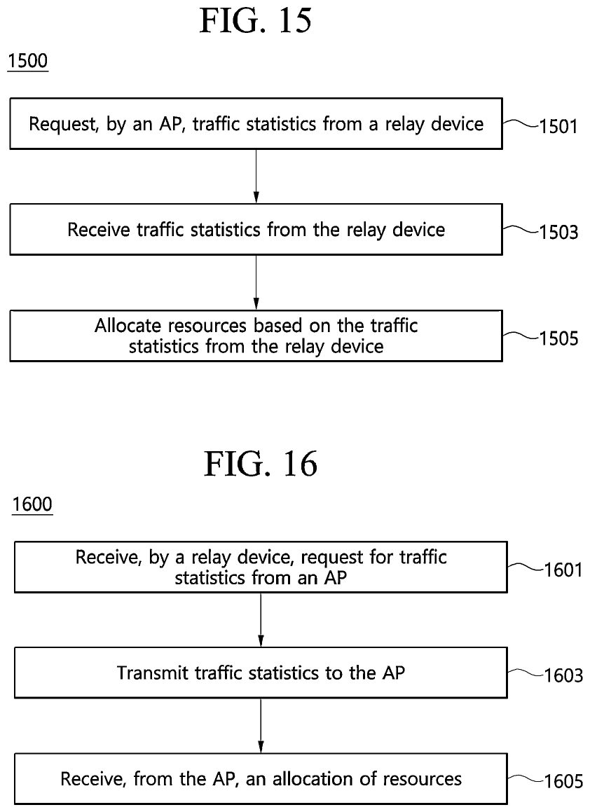

FIG. 15 illustrates a flow chart of an example process by an AP of obtaining traffic statistics in accordance with an embodiment. Although one or more operations are described or shown in particular sequential order, in other embodiments the operations may be rearranged in a different order, which may include performance of multiple operations in at least partially overlapping time periods. The flowchart depicted in FIG. 9 illustrates operations performed in an a AP MLD, such as AP MLD illustrated in FIG. 3.

The process 1500 begins in operation 1501.

In operation 1501, the AP requests from a relay device traffic statistics. In some embodiments, the AP may request traffic statistics for a target entity(s) (e.g., STA) from the relay device. In some embodiments, the request may be for target statics of the relay device. In certain embodiments, the request may be for cumulative target statistics of both the relay device and the target entity (e.g., STA).

In operation 1503, the AP receives traffic statistics from the relay device. In some embodiments, the AP may receive a response frame that includes the requested traffic statistics. The frame may include the target statistics of the target entity and/or the traffic statistics of the intermediate relay device.

In operation 1505, the AP allocates resources based on the traffic statistics. In some embodiments, the AP can determine the STA's traffic that is backlogged at the relay device and can differentiate that from the relay's own traffic. In some embodiments, the AP can provide an indication that the allocated resources are being shared only for transmission of the STA's traffic or for both the STA's traffic and the relay's traffic. In some embodiments, the AP can share the allocated resources that should be first used for transmission of the STA's traffic and after the STA's backlog is over, the remaining resources can be used to transmit the relay's traffic.

FIG. 16 illustrates a flow chart of an example process by a relay device of obtaining traffic statistics in accordance with an embodiment. Although one or more operations are described or shown in particular sequential order, in other embodiments the operations may be rearranged in a different order, which may include performance of multiple operations in at least 6 partially overlapping time periods. The flowchart depicted in FIG. 16 illustrates operations performed by a relay device, such as a relay device illustrated in FIG. 5.

The process 1600 begins in operation 1601.

In operation 1601, the relay device receives from an AP a request for traffic statistics. In some embodiments, the AP may request traffic statistics for a target entity(s) (e.g., STA) from the relay device. In some embodiments, the request may be for target statics of the relay device. In certain embodiments, the request may be for cumulative target statistics of both the relay device and the target entity (e.g., STA).

In operation 1603, the relay device transmits traffic statistics to the AP. In some embodiments, the relay device may transmit a response frame that includes the requested traffic statistics. The frame may include the target statistics of the target entity and/or the traffic statistics of the intermediate relay device.

In operation 1605, the relay receives from the AP an allocation of resources. In some embodiments, the relay may receive an indication that the allocated resources are being shared only for transmission of an STA's traffic or for both the STA's traffic and the relay's traffic. In some embodiments, the allocated resources may need to be first used for transmission of the STA's traffic and after the STA's backlog is over, the remaining resources can be used to transmit the relay's traffic.

Accordingly, when an AP requests traffic statistics from a relay, the AP is able to request statistics of the STA whose traffic the relay is handling as well. Thus, the AP can get an idea of the STA's traffic that is backlogged at the relay and can be able to differentiate that from the relay's traffic statistics in the legacy report. These types of reporting may allow for differentiation of traffic from different entities to provide for better network management and optimizing network traffic.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) station in a wireless network, the AP comprising:
a communication interface to communicate with one or more relay stations (STAs); and
a processor coupled to the communication interface, the processor configured to:
establish a logical AP multi-link device (MLD) comprising the AP and the one or more relay STAs, wherein the logical AP MLD comprises an upper medium access control (UMAC) layer in the AP and a lower MAC (LMAC) layer in the one or more relay STAs;
wherein an UMAC operation is performed at the AP and a LMAC operation is performed at the one or more relay STAs.

2. The AP of claim 1, wherein an advertising function is provided by a UMAC layer of a relay STA and a traffic handling function is provided by the UMAC layer of the AP.

3. The AP of claim 1, wherein the one or more relay STAs include a plurality of LMACs that are part of different MLDs and are controlled by the UMAC layer of the AP for relay operation.

4. The AP of claim 1, wherein the processor is further configured to receive a message from the one or more relay STAs that includes information about a configuration of the one or more relay STAs.

5. The AP of claim 4, wherein the message includes information about capabilities of the one or more relay STAs.

6. The AP of claim 1, wherein the processor is further configured to transmit an advertisement message that includes information on the one or more relay STAs.

7. A relay station (STA) station in a wireless network, the relay STA comprising:
a communication interface to communicate with an access point (AP); and
a processor coupled to the communication interface, the processor configured to:
establish a logical AP multi-link device (MLD) comprising the AP and the relay STA, wherein the logical AP MLD comprises an upper medium access control (UMAC) layer in the AP and a lower MAC (LMAC) layer in the one or more relay STAs;
wherein an UMAC operation is performed at the AP and a LMAC operation is performed at the relay STA.

8. The relay STA of claim 7, wherein an advertising function is provided by a UMAC layer of the relay STA and a traffic handling function is provided by the UMAC layer of the AP.

9. The relay STA of claim 7, further comprising a plurality of LMACs that are part of different MLDs and are controlled by the UMAC layer of the AP for relay operation.

10. The relay STA of claim 7, wherein the processor is further configured to transmit a message to the AP that includes information about a configuration of the relay STA.

11. The relay SWA of claim 10, wherein the message includes information about capabilities of the relay STA.

12. The relay STA of claim 7, wherein the processor is further configured to transmit an advertisement message that includes information on the relay STA.

13. The relay STA of claim 7, wherein the relay STA further comprises one or more physical layers (PHYs), wherein the one or more PHYs are configured to communicate with one or more STAs and the one or more PHYs are configured to communicate with the AP.

14. The relay STA of claim 13, wherein the relay STA transmits and receives traffic using a first PHY in the one or more PHYs.

15. A computer-implemented method for wireless communication by an access point (AP) in a wireless network, comprising:
establishing a logical AP multi-link device (MLD) comprising the AP and one or more relay STAs, wherein the logical AP MLD comprises an upper medium access control (UMAC) layer in the AP and a lower MAC (LMAC) layer in the one or more relay STAs;
wherein an UMAC operation is performed at the AP and a LMAC operation is performed at the one or more relay STAs.

16. The computer-implemented method of claim 15, wherein an advertising function is provided by a UMAC layer of a relay STA and a traffic handling function is provided by the UMAC layer of the AP.

17. The computer-implemented method of claim 15, wherein each STA includes a plurality of LMAC layers that are part of different MLDs and are controlled by the UMAC layer of the AP for relay operation.

18. The computer-implemented method of claim 15, further comprising receiving a message from the one or more relay STAs that includes information about a configuration of the one or more relay STAs.

19. The computer-implemented method of claim 18, wherein the message includes information about capabilities of the relay STA.

20. The computer-implemented method of claim 15, further comprising transmitting an advertisement message that includes information on the one or more relay STAs.
